(19) United States
(12) Patent Application Publication
(10) Pub. No.: US 2013/0050288 A1
(43) Pub. Date: Feb. 28, 2013

(54) LED DRIVER APPARATUS

(71) Applicants: Tae-kyoung Kang, Cheongju-si (KR); Gyo-ho Lim, Cheongju-si (KR); Hyoung-kyu Kim, Cheongju-si (KR)

(72) Inventors: Tae-kyoung Kang, Cheongju-si (KR); Gyo-ho Lim, Cheongju-si (KR); Hyoung-kyu Kim, Cheongju-si (KR)

(73) Assignee: MAGNACHIP SEMICONDUCTOR, LTD., Cheongju-si (KR)

(21) Appl. No.: 13/586,059

(22) Filed: Aug. 15, 2012

(30) Foreign Application Priority Data
Aug. 30, 2011 (KR) 10-2011-0087461

(51) Int. Cl. H05B 37/02; G09G 3/36; G09G 5/10

(52) U.S. Cl. 345/690; 315/307; 345/87

(57) ABSTRACT

A Light Emitting Diode (LED) driving apparatus and a method of driving a LED backlight unit are provided. An LED driving apparatus includes: an input unit configured to receive a dimming signal, an extension unit configured to extend ON time of the inputted dimming signal, an LED driving unit configured to drive an LED array using the extended dimming signal, and a detection unit configured to detect a degradation of the LED array by measuring a forward voltage between the LED array and the LED driving unit.

### CROSS-REFERENCE TO RELATED APPLICATIONS

This application claims the benefit under 35 U.S.C. §119(a) of Korean Patent Application No. 10-2011-0087461, filed on Aug. 30, 2011 in the Korean Intellectual Property Office, the entire disclosure of which is incorporated herein by reference for all purposes.

### BACKGROUND

1. Field

The following description generally relates to a Light Emitting Diode (LED) driving apparatus, and such as, for example, an LED driving apparatus that is capable of detecting the degradation of an LED array.

2. Description of Related Art

Liquid Crystal Displays (LCDs) are widely used because they are relatively thin and light-weight in comparison to many other display apparatuses. In addition, LCDs require a low driving voltage and electricity to operate in comparison to many other display apparatuses. However, because a liquid crystal panel by itself does not emit light, an LCD requires a separate backlight unit (BLU) to supply light to the liquid crystal panel.

A Cold Cathode Fluorescent Lamp (CCFL) or a Light Emitting Diode (LED) is often used as a light source for the backlight unit of an LCD. However, CCFLs use mercury in their fluorescent lamps; thus, CCFLs impose risks of environmental pollution. Further, CCFLs have shortcomings such as slow responsiveness, low color representation, and the like. In addition, CCFLs are not suitable for an LCD that is light-weight, thin, short and/or small in size.

On the contrary, LEDs are environment-friendly in that LEDs do not use environmentally harmful materials such as mercury, and enable impulse driving. In addition, an LED backlight unit is capable of providing a good color representation because the brightness or color temperature of the LED backlight unit can be freely controlled by appropriately adjusting the luminescence of red, green, and blue light emitting diodes. Further, LEDs are also suitable for obtaining an LCD that is light, thin, short and/or small. Thus, LEDs have recently been widely used as the backlight source for LCDs, or the like.

When a plurality of LEDs are connected in series to each other in an LCD backlight that utilizes LEDs, such as when an LED array is used as the backlight source for an LCD panel, a driving circuit may be necessary to provide a constant current to the LEDs, and a DC-DC converter may be necessary to regulate electricity supplied to the LEDs.

Meanwhile, considering that an LED array sometimes fails ‘open’ or ‘short’ due to a prolonged driving of the array or due to a physical impact, a protective circuit may be necessary to detect the degradation of an LED array. For instance, an individual LED in an LED array may fail electrically ‘open’ or electrically ‘short.’ When an individual LED fails ‘open,’ the electric circuit is in an open state and the power supply may be cut off from other LEDs connected in series with the failed LED. In instances in which an individual LED fails ‘short,’ the current continues to flow through other LEDs connected in series with the failed LED.

For example, a protective circuit may detect the degradation of the LED array by measuring the forward voltage (V_{FB}) of an LED array. However, a conventional protective circuit may erroneously determine that an LED array has degraded when actually the settling time of the constant current source is slow or when an abnormal forward voltage (V_{FB}) is detected due to a peak current of the constant current, irrespective of whether the LED array has actually degraded.

Referring to FIG. 6, the current flows to the LED array as a dimming signal (PWM signal) is on, causing the forward voltage (V_{FB}) to gradually decrease. However, due to a rather slow settling time of the constant current source, if the forward voltage drops as illustrated by V_{FB[A]} in FIG. 6, the conventional protective circuit may measure the forward voltage in such a section. When the forward voltage is measured in such a section, the measured forward voltage is higher than a normal one, and as a result, the protective circuit may determine that the corresponding LED array has failed short.

Also, the conventional protective circuit sometimes measures forward voltage in the section when the forward voltage drops close to 0V due to the peak current of the constant current. However, when the forward voltage is measured in such a section, the measured voltage is lower than a normal forward voltage; as a result, the protective circuit may determine that the LED array has failed open.

### SUMMARY

In one general aspect, there is provided a Light Emitting Diode (LED) driving apparatus including: an input unit configured to receive a dimming signal, an extension unit configured to extend ON time of the inputted dimming signal, an LED driving unit configured to drive an LED array using the extended dimming signal, and a detection unit configured to detect a degradation of the LED array by measuring a forward voltage between the LED array and the LED driving unit.

The detection unit may be configured to detect the degradation by measuring the forward voltage at a time of declining edge of the inputted dimming signal.

The extension unit may include: a delay unit configured to delay the inputted dimming signal, and an OR gate configured to receive the inputted dimming signal and the delayed dimming signal and outputs an extended dimming signal.

The delay unit may be configured to delay the inputted dimming signal by 100 ns to 1000 ns.

In response to a substantially entire portion of the dimming signal being duty signal, a clock signal having a preset frequency may be provided to the detection unit instead of the inputted dimming signal.

The extension unit may include a multiplexer configured to provide one of the inputted dimming signal and the clock signal having the preset frequency to the detection unit, depending on whether or not a substantially entire portion of the dimming signal is duty signal.

The clock signal may be used for generating a PWM signal to adjust a driving voltage of the LED array.

The detection unit may be configured to determine that the LED array is in an open state in response to the measured forward voltage being smaller than a first preset voltage, and is configured to determine that the LED array is in a shorted state in response to the measured forward voltage being larger than a preset second voltage, and the first preset voltage may be smaller than the forward voltage when LEDs in the LED array are each in a working state, and the second preset voltage may be larger than the forward voltage when LEDs in the LED array are each in a working state.

The detection unit may include: a first comparator configured to compare the measured forward voltage and a first preset voltage to determine whether the measured forward voltage is smaller than the first preset voltage, a second comparator configured to compare the measured forward voltage and a second preset voltage to determine whether the measured forward voltage is larger than the second preset voltage, a first determining unit configured to determine whether or not the LED array is in an open state depending on an output from the first comparator, when the inputted dimming signal is at a declining edge, and a second determining unit configured to determine whether or not the LED array is in a shorted state depending on an output from the second comparator, when the inputted dimming signal is at a declining edge.

The first determining unit may include: a first inverter configured to inverse the inputted dimming signal and outputs a result, and a first data flip-flop configured to receive the inversed dimming signal from the first inverter as a clock signal, and receive the output from the first comparator as a data signal, and the second determining unit may include: a second inverter configured to inverse the inputted dimming signal and outputs a result, and a first data flip-flop configured to receive the inversed dimming signal from the second inverter as a clock signal, and receive the output from the second comparator as a data signal.

The first preset voltage may be smaller than the forward voltage when LEDs in the LED array are each in a working state, and the second preset voltage may be larger than the forward voltage when LEDs in the LED array are each in a working state.

In another general aspect, there is provided a Liquid Crystal Display (LCD) including a liquid crystal panel, and an LED driving apparatus of claim 1.

In yet another general aspect, there is provided a method of driving an LED backlight unit, the method involving extending an ON time of an inputted dimming signal, driving an LED array using the extended dimming signal, and detecting a degradation of the LED array by measuring a forward voltage between the LED array and the LED driving unit at a time of a declining edge of the inputted dimming signal.

In the general aspect of the method of driving an LED backlight unit, the inputted dimming signal may be received from an external source.

In the general aspect of the method of driving an LED backlight unit, the extension may involve: delaying the inputted dimming signal, and receiving the inputted dimming signal and the delayed dimming signal at an OR gate and outputting an extended dimming signal.

In the general aspect of the method of driving an LED backlight unit, the inputted dimming signal may be delayed by 100 ns to 1000 ns.

Throughout the drawings and the detailed description, unless otherwise described, the same drawing reference numerals will be understood to refer to the same elements, features, and structures. The relative size and depiction of these elements may be exaggerated for clarity, illustration, and convenience.

### BRIEF DESCRIPTION OF THE DRAWINGS

FIG. 1 is a diagram illustrating an example of an LED driving apparatus.

FIG. 2 is a circuit diagram of an example of an LED driving unit and an LED array.

FIG. 3 is a circuit diagram illustrating an example of an extension unit that may be used in the LED driving apparatus illustrated in FIG. 1.

FIG. 4 is a circuit diagram illustrating an example of a detection unit that may be used in the LED driving apparatus illustrated in FIG. 1.

FIG. 5 is a waveform provided to explain the operation of the example of extension unit illustrated in FIG. 3.

FIG. 6 is a waveform provided to explain a change of an abnormal forward voltage in the settling time of a constant current source or due to a peak current of the constant current.

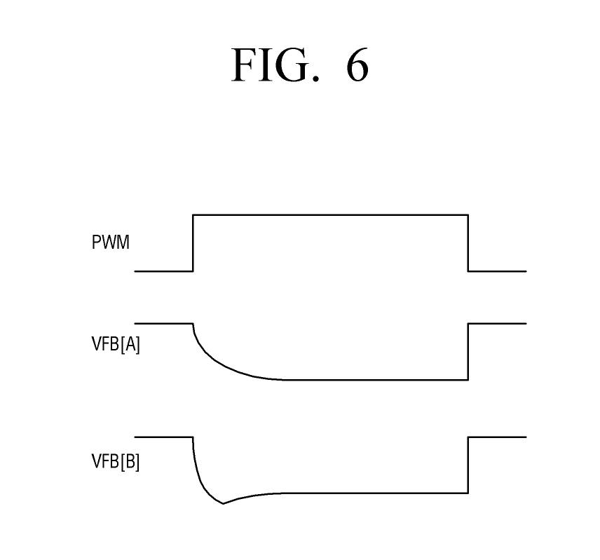

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

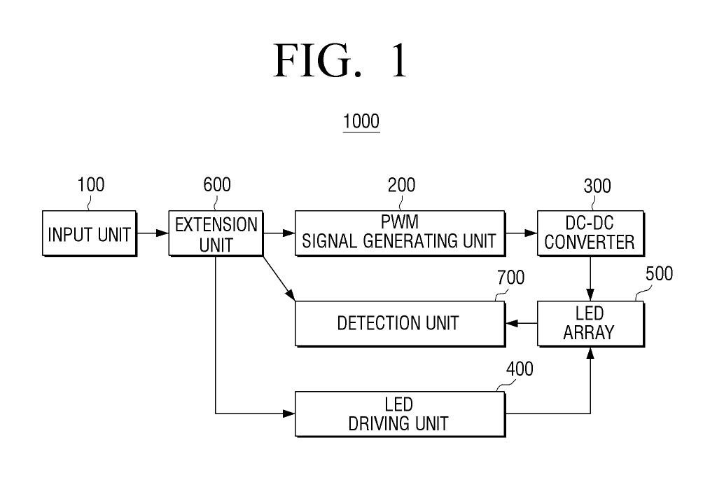

FIG. 1 illustrates an example of an LED driving apparatus.

Referring to FIG. 1, an LED driving apparatus 1000 includes an input unit 100, a Pulse Width Modulation (PWM) signal generating unit 200, a DC-DC converter 300, an LED driving unit 400, an LED array 500, an extension unit 600 and a detection unit 700.

The input unit 100 receives a dimming signal to drive the LED array 500. Examples of digital dimming methods that may be used with an LED array include, but are not limited to, a direct mode, a fixed phase mode, and a phase shift mode. In a direct mode, both the PWM frequency and On-Duty signal are controlled from outside. For example, a Packet Assembler/Disassembler (PAD) can control the PWM frequency and On-Duty signal. In a fixed phase mode or phase shift mode, the PWM frequency is generated in an integrated circuit (IC), and the On-Duty signal is controlled in accordance with the input from the PAD. As used herein, the ‘dimming signal’ refers to a signal used to adjust brightness and color temperature of the LED light, or to compensate for the color temperature. Although the direct mode is explained as an example in which the dimming signal is inputted from outside, in other examples, a fixed phase mode or phase shift mode may be used to obtain the dimming signal.

The PWM signal generating unit 200 generates a PWM signal to adjust the power of the LED array 500. For example, the PWM signal generating unit 200 may generate a PWM signal to control the magnitude of the driving voltage of the DC-DC converter 300. The PWM signal generating unit 200 may generate a PWM signal based on a clock signal having a preset frequency, by extending or reducing the ON time of the clock signal.

The DC-DC converter 300 includes a transistor for performing a switching operation. The driving voltage is provided to the LED array 500 in accordance with the switching operation at the transistor. For example, the DC-DC converter 300 converts DC voltage based on the PWM signal generated at the PWM signal generating unit 200, and provides the converted DC voltage (i.e., driving voltage) to the LED array 500. The DC-DC converter 300 may provide the voltage corresponding to forward bias voltage of the LED array 500 to the LED array 500 so that the LED array 500 may operate in a current saturation range.

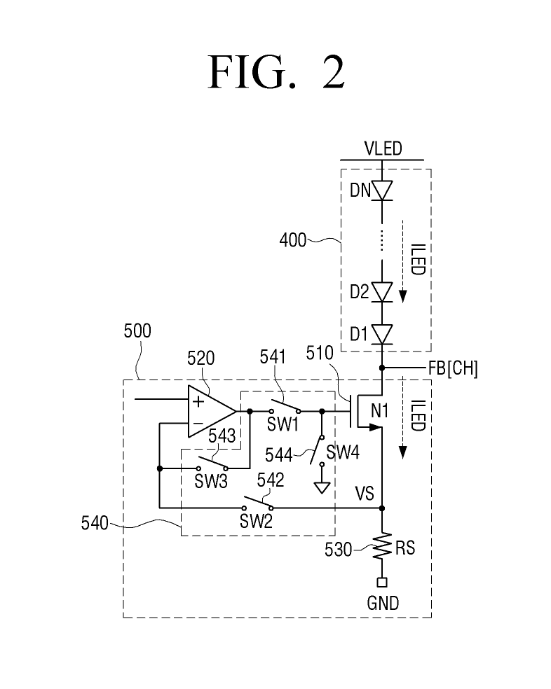

The LED driving unit 400 drives the LED array 500 using the extended dimming signal. For example, the LED driving unit 400 may adjust the driving current within the LED array 500 by using the dimming signal having ON time that is extended at the extension unit 600. The construction and operation of the LED driving unit 400 are further explained below with reference to FIG. 2.

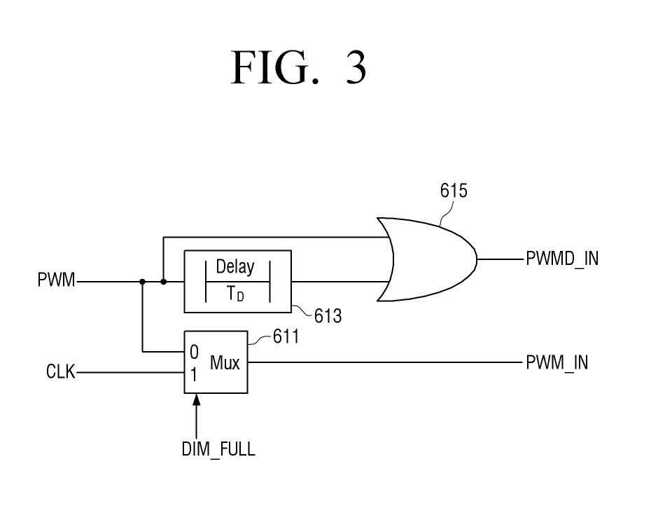

The extension unit 600 extends the ON time of the inputted dimming signal. For instance, the extension unit 600 may delay the ON time of the dimming signal inputted through the input unit 100 by 100 ns˜1000 ns and provides the resultant signal to the LED driving unit 400. The construction and operation of the extension unit 600 are further explained below with reference to FIG. 3.

The detection unit 700 detects the degradation of the LED array 500 by measuring a forward voltage of the LED array 500 at a time of a declining edge of the inputted dimming signal. For instance, in the event that the inputted dimming signal is smaller than a first preset voltage, the detection unit 700 determines that the LED array 500 is in an open state; in the event that the inputted dimming signal is larger than a second preset voltage, the detection unit 700 determines that the LED array 500 failed short. As used herein, the ‘first preset voltage’ is smaller than the forward voltage in the normal operation of the LED array 500, and the ‘second preset voltage’ is larger than the forward voltage in the normal operation of the LED array 500. The first and second preset voltages may vary in magnitude depending on the system, and may be set to optimized voltage values selected by a manufacturer as a result of experiments.

As explained above, the LED driving apparatus 1000 is capable of detecting whether the LED array 500 is degraded or not, irrespective of the settling time of the constant current source or the presence of an abnormal forward voltage generated due to a peak current of the constant current. This is because the LED driving apparatus 1000 detects the degradation of the LED array 500 by measuring the magnitude of the voltage at a time when the forward voltage is most stable.

FIG. 2 illustrates a circuit diagram of an example of a plurality of LED driving units.

Referring to FIG. 2, the LED driving unit 500 may include a transistor 510, a comparator 520, a resistor 530, and a plurality of switches 541, 542, 543, 544.

The transistor 510 performs switching operations according to an output signal from the comparator 520 and the connection between the plurality of switches 541, 542, 543, 544. For instance, the drain of the transistor 510 may be connected to one end of the LED array 400, the source may be connected to the resistor 530 and the gate may be connected to an output end of the comparator 520 via the plurality of switches 541, 542, 543, 544. Although n-MOS transistor is used in the example illustrated herein, one will understand that other device may also be used.

The comparator 520 controls the transistor 510 by comparing the voltage (V_{S}) of a common node commonly contacting the switching unit 540 and the resistor 530 with a reference voltage (V_{REF}). For instance, the comparator 520, which may be implemented with an Operational Amplifier (Op-Amp), may receive V_{REF} at a positive terminal, and may receive V_{S} of the common node between the resistor 530 and the transistor 510 at a negative terminal. The output end is connected to the gate of the transistor 510 through a plurality of switches 541, 542, 543, 544.

The resistor 530 is connected at one end to the source of the transistor 510, and grounded at the other end.

A switching unit 540 comprising a plurality of switches 541, 542, 543, 544 selectively provides the output signal of the comparator 520 to the transistor 510 in accordance with the extended dimming signal. For instance, the switching unit 540 includes a first switch 541, a second switch 542, a third switch 543 and a fourth switch 544.

The first switch 541 is arranged between the comparator 520 and the gate of the transistor 510, and is in a closed state when the extended dimming signal is on, and in an open state when the extended diming signal is off.

The second switch 542 is arranged between a common node between the source of the transistor 520 and the resistor 530 and the negative terminal, and is in a closed state when the extended dimming signal is on, or in an open state when the extended dimming signal is off.

The third switch 543 is arranged between a negative terminal of the transistor 520 and an output end of the transistor 520. The third switch 543 is in an open state when the extended dimming signal is on, and in a closed state when the extended dimming signal is off.

The fourth switch 544 is arranged between the gate and the ground of the transistor 520. The fourth switch 544 is in an open state when the extended dimming signal is on and in a closed state when the extended dimming signal is off.

Accordingly, when the extended dimming signal is on, the first and second switches 541, 542 are in a closed state, and the third and fourth switches 543, 544 are in an open state, in which case the comparator 520 compares the voltage (V_{S}) of the common node between the switching unit 540 and the resistor 530 with the reference voltage (V_{REF}) to control the transistor 510.

On the contrary, if the extended dimming signal is off, the first and second switches 541, 542 are in a closed state, and the third and fourth switches 543, 544 are in an open state. In this case, the gate of the transistor 510 is connected to the ground to block the supply of constant current to the LED array 500.

FIG. 3 illustrates a circuit diagram of an example of an extension unit suitable for the example of LED driving apparatus depicted in FIG. 1.

Referring to FIG. 3, the extension unit 600 includes a multiplexer 611, a delay unit 613, and an OR gate 615.

The multiplexer 611 provides the detection unit 700 with one of the inputted dimming signal and the clock signal having a preset frequency, depending on whether the inputted dimming signal (PWM signal) is 100% duty signal. As an approximation, it can be determined whether a substantially entire portion of the inputted dimming signal is duty signal. Here, a “substantially entire portion” refers to approximately at least 98% or more and includes the entire 100%. For instance, while the detection unit measures the forward voltage in the declining edge of the dimming signal, there is no declining edge if the dimming signal (PWM signal) is substantially entirely, or 100%, duty signal.

Accordingly, in the event that the inputted dimming signal (PWM signal) is 10% duty signal, for example, the multiplexer 611 may provide the detection unit 700 with the internal clock signal of the LED driving apparatus 1000 instead of the inputted dimming signal. In the example illustrated in FIG. 3, a signal indicative of whether the dimming signal is 100% (or substantially entirely) duty signal or not may be inputted as a control signal of the multiplexer 611. That is, in the example illustrated and explained with reference to FIG. 3, a separate part determines whether the inputted dimming signal is 100% (or substantially entirely) duty signal or not. However, in another example, the extension unit 600 itself may determine whether or not the inputted dimming signal is 100% (or substantially entirely) duty signal.

As used herein, the ‘clock signal’ refers to a clock signal used in generating a PWM signal to adjust the driving voltage of the LED array 500. The clock signal is used when generating the PWM signal at the PWM signal generating unit 200.

The delay unit 613 delays the dimming signal inputted through the input unit 100. The delay unit 613 may delay the inputted dimming signal in the range between 100 ns and 1000 ns.

The OR gate 615 receives the inputted dimming signal and the delayed dimming signal to output an extended dimming signal. For example, the OR gate 615 receives the inputted dimming signal and the output from the delay unit 613, and output a logic OR of the inputted dimming signal and the delayed dimming signal as an extended dimming signal.

Based on the example explained above, the extension unit 600 may extend the ON time of the inputted dimming signal from the input unit 100 and output the result.

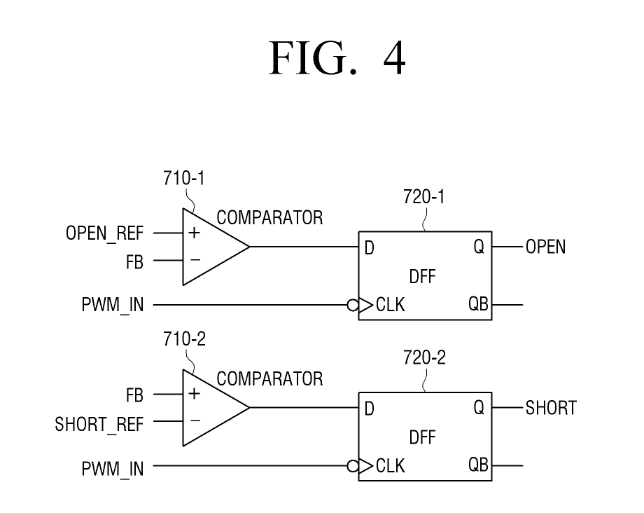

FIG. 4 illustrates a circuit diagram of an example of the detection unit depicted in FIG. 1.

Referring to FIG. 4, the detection unit 700 includes a first comparator 710-1, a second comparator 710-2, a first determining unit 720-1 and a second determining unit 720-2.

The first comparator 710-1 compares a forward voltage and the first preset voltage to determine if the measured forward voltage is smaller than the first preset voltage. For instance, the first comparator 710-1 may be implemented as an Op-Amp that receives the forward voltage of the LED array 500 at a negative terminal and receives the first preset voltage at a positive terminal. As used herein, the ‘first preset voltage’ is the voltage smaller than the forward voltage during a normal operation of the LED array 500. The normal operation of the LED array 500 refers to a state in which LEDs in the LED array 500 are each in a working state, without having failed open or short.

The second comparator 710-2 compares a measured forward voltage and the second present voltage to determine if the measured forward voltage is larger than the second preset voltage. For instance, the second comparator 710-2 may be implemented with an Op-Amp that receives the forward voltage of the LED array 500 at the positive terminal and receives the first preset voltage at the negative terminal and output the difference therebetween. As used herein, the ‘second preset voltage’ refers to the voltage larger than the forward voltage during the normal operation of the LED array 500, when the LEDs are each in a working state.

The first determining unit 720-1 determines whether the LED array 500 is in an open state in accordance with the output of the first comparator 710-1, when the inputted dimming signal is in a declining edge. In this example, the first determining unit 720-1 may include a first inverter and a first data flip-flop.

The first inverter inverses the inputted dimming signal and output the result.

The first data flip-flop receives the inversed dimming signal of the first inverter as a clock signal, and receives an output from the first comparator 710-1 as a data signal. Accordingly, the first data flip-flop may determine if the forward voltage is in an open state immediately before the extended dimming signal ends, for instance, before the delay time of the delay unit 613 from the declining edge of the extended diming signal.

The second determining unit 720-2 determines whether or not the LED array 500 is in a shorted state in accordance with the output from the second comparator 710-2, when the inputted dimming signal is in a declining edge. For instance, the second determining unit 720-2 may include a second inverter and a second data flip-flop.

The second inverter inverses the inputted dimming signal and outputs the result.

The second data flip-flop receives the inversed dimming signal of the second inverter as a clock signal, and receives an output from the second comparator 720-2 as a data signal. Accordingly, the first data flip-flop may determine if the forward voltage is in an open state immediately before the extended dimming signal is ended—for instance, before delay time of the delay unit 613 from the declining edge of the extended diming signal.

Although the determining units 720-1, 720-2 are implemented using the data flip-flops in the example explained above, the determining unit 720 may be implemented with flip-flops other than the data flip-flops in other examples. Further, although it was illustrated and explained that the determining units 720 each uses a separate inverter, considering that the first and second flip-flops receive the same signal as the clock, the determining units 720-1, 720-2 may be implemented using one single inverter.

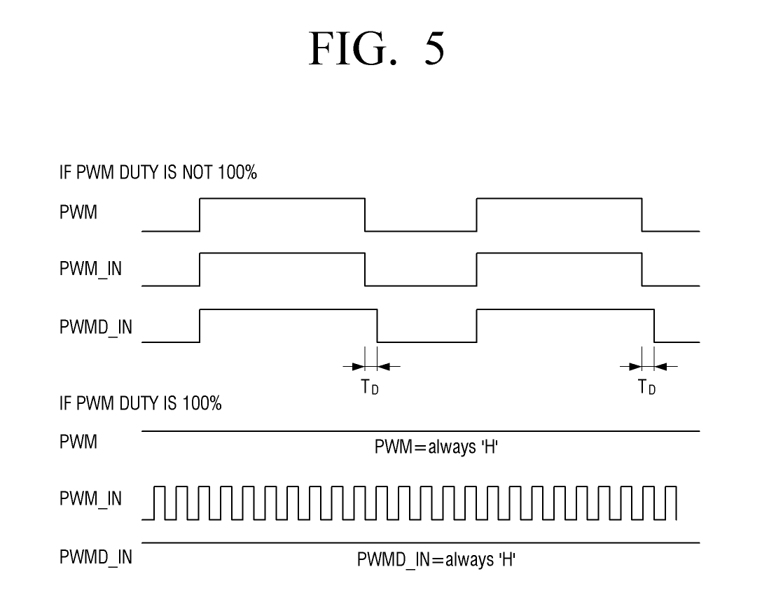

FIG. 5 illustrates a waveform provided to explain the operation of the extension unit of FIG. 3.

The forward voltage of the LED array 500 has the most stable voltage at a time immediately before the LED array stops driving. That is, the most stable voltage is obtained immediately before the declining edge of the dimming signal. However, since it is impossible to anticipate when the dimming signal turns from high to low signal, the ON time of the dimming signal may be slightly extended as in an example illustrated in FIG. 5, and the extended dimming signal may be provided to the LED driving unit 400.

With the construction as explained above, the LED driving apparatus 1000 can measure the forward voltage and detect the presence of degradation in the LED array, immediately before the declining edge of the extended dimming signal (i.e., immediately before the declining edge of the inputted dimming signal). Meanwhile, in order to distinguish the extended dimming signal from the inputted dimming signal, FIG. 5 emphasizes the difference between the two signals. However, the dynamic characteristic at the LED driving unit 400 is relatively small, because, as illustrated, the extension unit 600 extends the inputted dimming signal by only 100 ns to 1000 ns of time.

It is possible to confirm that the extended dimming signal PWMD_IN is also 100% duty signal or substantially entirely duty signal, if the dimming signal is 100% duty signal or substantially entirely duty signal. The extension unit may confirm that the clock signal having a preset frequency is provided to the detection unit 700 as a dimming signal.

Referring to FIGS. 1 to 5, an example of detecting the degradation of one LED array 500 has been explained. However, in another example, there can be a plurality of LED arrays in the LED driving apparatus. In such an example, the LED driving apparatus may be implemented in a form which detects the degradation of each of the plurality of LED arrays.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A Light Emitting Diode (LED) driving apparatus, comprising:
an input unit configured to receive a dimming signal;
an extension unit configured to extend an ON time of the inputted dimming signal;
an LED driving unit configured to drive an LED array using the extended dimming signal; and
a detection unit configured to detect a degradation of the LED array by measuring a forward voltage between the LED array and the LED driving unit.

2. The LED driving apparatus of claim 1, wherein the detection unit is configured to detect the degradation by measuring the forward voltage at a time of declining edge of the inputted dimming signal.

3. The LED driving apparatus of claim 2, wherein the extension unit comprises:
a delay unit configured to delay the inputted dimming signal; and
an OR gate configured to receive the inputted dimming signal and the delayed dimming signal and to output an extended dimming signal.

4. The LED driving apparatus of claim 3, wherein the delay unit is configured to delay the inputted dimming signal by 100 ns to 1000 ns.

5. The LED driving apparatus of claim 2, wherein, in response to a substantially entire portion of the dimming signal being duty signal, a clock signal having a preset frequency is provided to the detection unit instead of the inputted dimming signal.

6. The LED driving apparatus of claim 5, wherein the extension unit comprises a multiplexer configured to provide one of the inputted dimming signal and the clock signal having the preset frequency to the detection unit, depending on whether or not a substantially entire portion of the dimming signal is duty signal.

7. The LED driving apparatus of claim 5, wherein the clock signal is used for generating a PWM signal to adjust a driving voltage of the LED array.

8. The LED driving apparatus of claim 2, wherein the detection unit is configured to determine that the LED array is in an open state in response to the measured forward voltage being smaller than a first preset voltage, and is configured to determine that the LED array is in a shorted state in response to the measured forward voltage being larger than a preset second voltage, and
wherein the first preset voltage is smaller than the forward voltage when LEDs in the LED array are each in a working state, and the second preset voltage is larger than the forward voltage when LEDs in the LED array are each in a working state.

9. The LED driving apparatus of claim 2, wherein the detection unit comprises:
a first comparator configured to compare the measured forward voltage and a first preset voltage to determine whether the measured forward voltage is smaller than the first preset voltage;
a second comparator configured to compare the measured forward voltage and a second preset voltage to determine whether the measured forward voltage is larger than the second preset voltage;
a first determining unit configured to determine whether or not the LED array is in an open state depending on an output from the first comparator, when the inputted dimming signal is at a declining edge; and
a second determining unit configured to determine whether or not the LED array is in a shorted state depending on an output from the second comparator, when the inputted dimming signal is at a declining edge.

10. The LED driving apparatus of claim 9, wherein the first determining unit comprises:
a first inverter configured to inverse the inputted dimming signal and outputs a result; and
a first data flip-flop configured to receive the inversed dimming signal from the first inverter as a clock signal, and receive the output from the first comparator as a data signal,
and the second determining unit comprises:
a second inverter configured to inverse the inputted dimming signal and outputs a result; and
a first data flip-flop configured to receive the inversed dimming signal from the second inverter as a clock signal, and receive the output from the second comparator as a data signal.

11. The LED driving apparatus of claim 9, wherein the first preset voltage is smaller than the forward voltage when LEDs in the LED array are each in a working state, and the second preset voltage is larger than the forward voltage when LEDs in the LED array are each in a working state.

12. A Liquid Crystal Display (LCD) comprising:
a liquid crystal panel; and
an LED driving apparatus of claim 1.

13. A method of driving an LED backlight unit, the method comprising:
extending an ON time of an inputted dimming signal;
driving an LED array using the extended dimming signal; and
detecting a degradation of the LED array by measuring a forward voltage between the LED array and the LED driving unit at a time of a declining edge of the inputted dimming signal.

14. The method of driving an LED backlight unit of claim 13, wherein the inputted dimming signal is received from an external source.

15. The method of driving an LED backlight unit of claim 13, wherein the extension involves:
delaying the inputted dimming signal; and
receiving the inputted dimming signal and the delayed dimming signal at an OR gate and outputting an extended dimming signal.

16. The method of driving an LED backlight unit of claim 15, wherein the inputted dimming signal is delayed by 100 ns to 1000 ns.
